(19) United States
(12) Patent Application Publication
(10) Pub. No.: US 2025/0306378 A1
(43) Pub. Date: Oct. 2, 2025

(54) HEAD-WEARABLE DEVICE FOR PRESENTING AND INTERACTING WITH EXTENDED REALITY AUGMENTS, AND SYSTEMS AND METHODS OF USE THEREOF

(71) Applicant: Meta Platforms Technologies, LLC, Menlo Park, CA (US)

(72) Inventors: Tianyi Wang, Redmond, WA (US); Tanya Renee Jonker, Seattle, WA (US); Michael Nebeling, Ypsilanti, MI (US); Felix Izarra, Redmond, WA (US)

(21) Appl. No.: 19/090,154

(22) Filed: Mar. 25, 2025

Related U.S. Application Data
(60) Provisional application No. 63/570,758, filed on Mar. 27, 2024.

(51) Int. Cl. G02B 27/01; G06F 3/01

(52) U.S. Cl. CPC G02B 27/0172; G06F 3/013; G06F 3/017

(57) ABSTRACT

A head-wearable device comprising one or more displays and one or more programs. The one or more programs include instructions for, in response to a detection of an object within a field-of-view of the user, presenting a first XR augment overlaid over a first portion of the field-of-view of the user that is associated with the object. The one or more programs further include instructions for, in accordance with a determination that a first user eye movement is focused on the first XR augment for a first predetermined time, replacing the first XR augment with a second XR augment. The one or more programs further include instructions for, in accordance with a determination that a second user eye movement is focused outside a perimeter of the second XR augment for a second predetermined time, replacing the second XR augment with a third XR element.

### RELATED APPLICATION

This application claims priority to U.S. Provisional Application Ser. No. 63/570,758, filed Mar. 27, 2024, entitled “Head-Wearable Device For Presenting And Interacting With Extended Reality Augments, And Systems And Methods Of Use Thereof,” which is incorporated herein by reference.

### TECHNICAL FIELD

This relates generally to extended-reality (XR) headsets, including but not limited to techniques for displaying XR augments that allow a user to interact with real-world objects and/or XR elements. The user interacts with the real-world objects and the XR elements by performing eye movements and/or hand gestures.

### BACKGROUND

Extended-reality (XR) headsets provide the opportunity to allow a user to augment their daily experience by providing convenient and engaging access to information and entertainment. However, one drawback to displaying an XR element over a user's view of the real-world, is that the XR elements can clutter the user's field-of-view and cause the user to be overwhelmed, disoriented, and distracted. Becoming disoriented and distracted can cause the user to become unaware of physical objects in their surrounding environment can lead to injury or other issues. Accordingly, there is a need for discrete XR augments that indicate to the users of XR headsets that an opportunity to interact with a real-world object and/or an XR element is available can prevent XR elements from cluttering the user's field-of-view. In addition, there is a desire for a technique for users of XR headsets to subtly select and interact with the XR augments and the XR elements, such that they do not substantially interfere with their surrounding environment.

As such, there is a need to address one or more of the above-identified challenges. A brief summary of solutions to the issues noted above are described below.

### SUMMARY

One example of a head-wearable device is described herein. This example head-wearable device comprises one or more displays, one or more imaging devices, and one or more programs. The one or more programs are stored in memory and are configured to be executed by one or more processors while the head-wearable device is worn by a user. The one or more programs include instructions for, in response to a detection of an object within a field-of-view of the user (e.g., a field-of-view that includes both physical and AR objects), presenting, via the one or more displays, a first XR augment overlaid over a first portion of the field-of-view of the user that is associated with the object. The one or more programs further include instructions for, in accordance with a determination that a first user eye movement (e.g., a saccade) is focused on the first XR augment for a first predetermined time, replacing the first XR augment with a second XR augment. The second XR augment appears to overlie a second portion (larger than the first portion in some embodiments) of the field-of-view of the user and includes one or more focus-action selectable elements. Each focus-action selectable element is associated with an object-specific action. The one or more programs further include instructions for, while the second XR augment is presented, in accordance with a determination that a second user eye movement is focused outside a perimeter of the second XR augment for a second predetermined time, replacing the second XR augment with a third XR element. The third XR element appears to overlie a third portion (larger than the second portion in some embodiments) of the field-of-view of the user and includes one or more object-specific selectable elements. Each object-specific selectable element is associated with a respective object-specific action.

Having summarized the first aspect generally related to use of a head-wearable device for selecting objects above, the second aspect generally related to use of a head-wearable device for interacting with an XR representation of an object is now summarized. This second example head-wearable device comprises one or more displays, one or more imaging devices, and one or more programs. The one or more programs are stored in memory and configured to be executed by one or more processors while the head-wearable device is worn by a user. The one or more programs include instructions for, in response to detecting an object within a field-of-view of the user, presenting, via the one or more displays, an XR augment, associated with the object. The one or more programs further include instructions for, in accordance with a determination that a first user eye movement is focused on a portion of the field-of-view of the user that is associated with the object, replacing the XR augment with a detailed XR augment, associated with the object. The detailed XR augment appears to overlie another portion of the field-of-view of the user. The one or more programs further include instructions for, in accordance with a determination that a second user eye movement is focused outside the portion of the field-of-view of the user, replacing the detailed XR augment with a peripheral XR augment, associated with the object.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1G illustrate an example head-wearable device for selecting objects within a field-of-view based on a gaze of a user, in accordance with some embodiments.

FIGS. 2A-2F illustrate an example head-wearable device for selecting an object from one or more objects within a field-of-view based on a gaze of a user, in accordance with some embodiments.

FIGS. 3A-3H illustrate an example head-wearable device 110 for interacting with an XR representation of an object, in accordance with some embodiments.

FIG. 4 shows an example method flow chart for selecting objects with the display of the head-wearable device, in accordance with some embodiments.

FIG. 5 shows an example method flow chart for interacting with an XR representation of an object with the display of the head-wearable device, in accordance with some embodiments.

FIGS. 6A-6C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRS. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

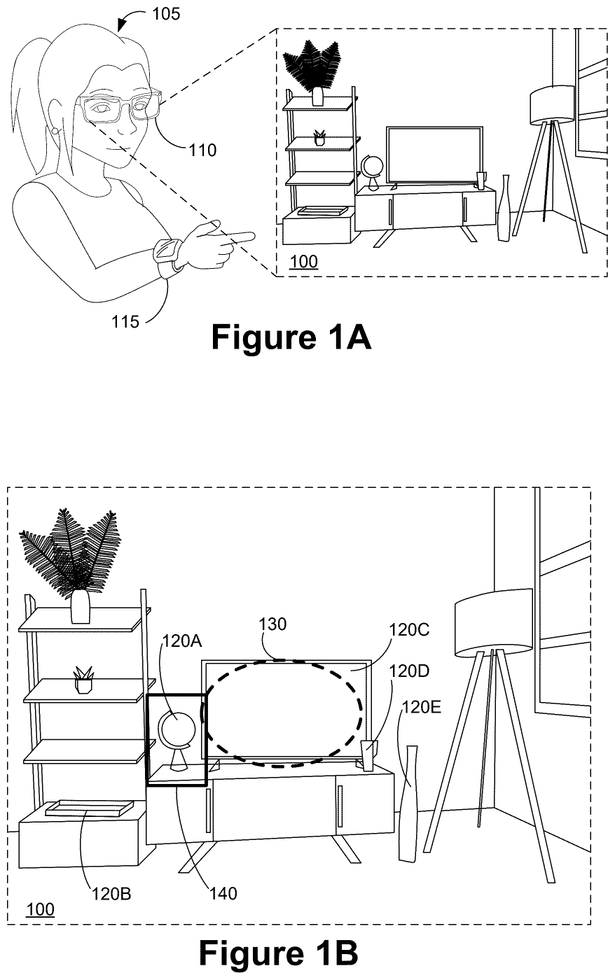

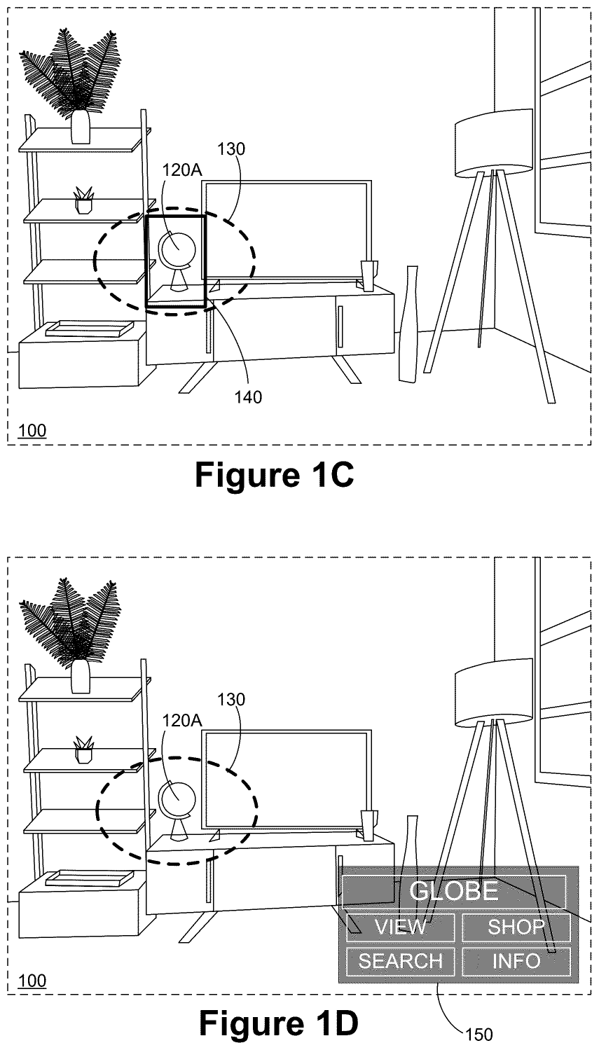

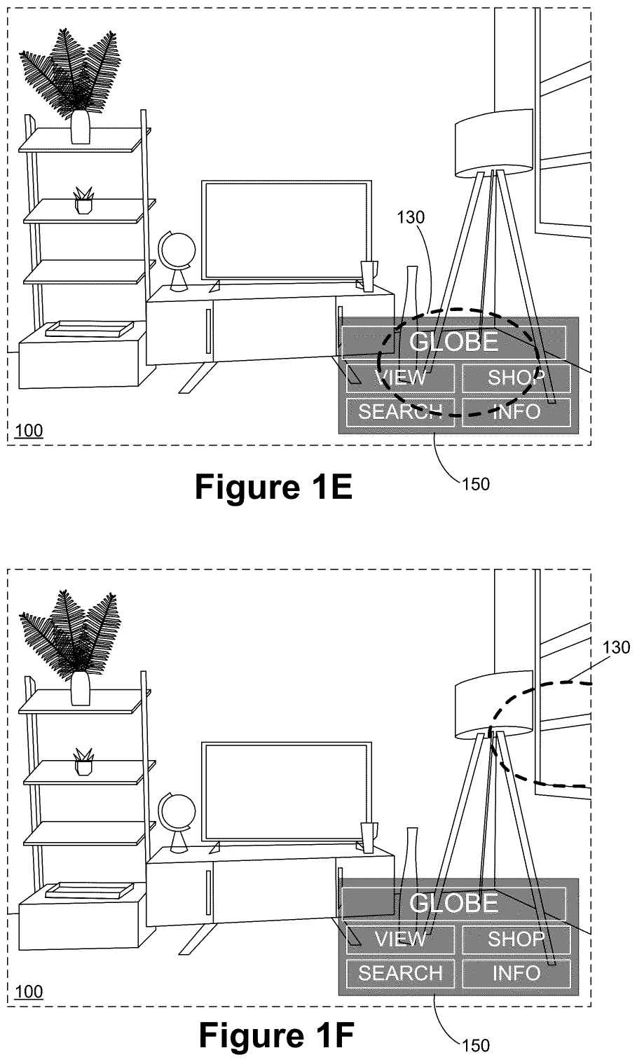

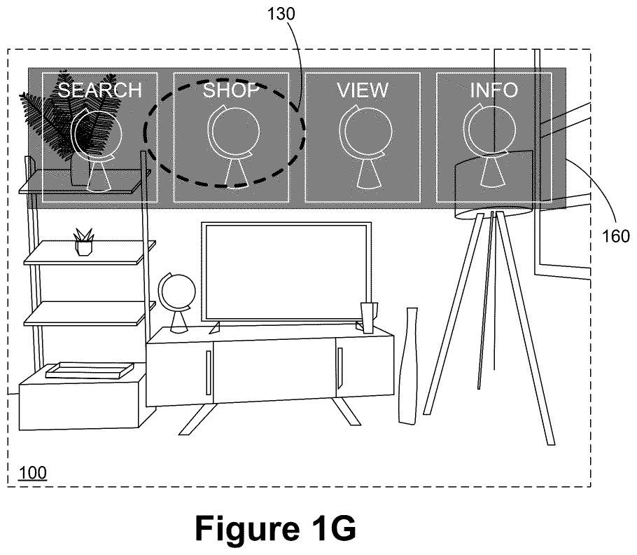

FIGS. 1A-1G illustrate an example head-wearable device 110 for selecting objects with a display of the head-wearable device 110, in accordance with some embodiments. In some embodiments, the head-wearable device 110 is communicatively coupled to a wrist-wearable device 115, a handheld intermediary processing device, and/or another processing device. The head-wearable device 110 includes one or more processors for executing one or more programs stored in a communicatively coupled memory device, the one or more programs configured to cause the performance of one or more operations or functions described below. In some embodiments, the one or more programs are stored in a memory device of the head-wearable device 110, or a memory device of the wrist-wearable device 115, the handheld intermediary processing device, and/or the other processing device.

In some embodiments, the head-wearable device 110 is a pair of extended-reality (XR) glasses (e.g., as illustrated in FIGS. 1A). The head-wearable device 110 includes one or more displays for presenting at least one XR augment while the head-wearable device 110 is worn by a user 105. The head-wearable device 110 includes one or more imaging devices (e.g., cameras) for capturing a field-of-view 100 of the user 105. In some embodiments, one of the one or more imaging devices include an eye-tracking camera for tracking eye movements of the user 105. In some embodiments, the head-wearable device 110 uses imaging data captured by the eye tracking camera to determine a focus of a gaze 130 of the user 105 (e.g., a location of the user's gaze 130, which is represented as a dashed oval, as illustrated in FIGS. 1A-3H). Additionally, or alternatively, in some embodiments, the head-wearable device 110 uses data captured by one or more inertial measurement units (IMUs) of the head-wearable device 110 to determine the focus of a gaze 130 of the user 105. In some embodiments, the head-wearable device includes a speaker for presenting audio cues to the user 105.

FIG. 1B illustrates the field-of-view 100 of the user 105 with at least one object 120A-120E and at least one XR augment 140 displayed by the head-wearable device 110, in accordance with some embodiments. The one or more imaging devices of the head-wearable device 110 capture the field-of-view 100 of the user 105 and the captured image data is used to identify one or more objects 120A-120E (e.g., a globe 120A, a tray 120B, a television 120C, a mug 120D, or a vase 120E, as illustrated in FIGS. 1A-3F) within the field-of-view 100 of the user 105. In some embodiments, at least one object 120A-120E includes at least one XR augment displayed by the head-wearable device 110. For example, in response to identifying the object 120A (e.g., the globe 120A, as illustrated in FIG. 1B), the head-wearable device 110 displays a first XR augment 140 (e.g., a box around the globe 120A, as illustrated in FIG. 1B) that appears over a first portion of the field-of-view 100. In some embodiments, the XR augments are presented when the user's gaze is adjacent (e.g., within 1 mm, 2 mm, etc.) to an object of the at least one object 120A-120-E. In some embodiments, the XR augments are optional.

In some embodiments, the first portion of the field-of-view 100 is associated with the object 120A (e.g., the first portion is a portion of the field-of-view 100 that includes and/or immediately surrounds the object 120A, as illustrated in FIG. 1B). In some embodiments, the first XR augment 140 is a box, circle, oval, or other shape that appears to surround the object 120A, a representation of the object 120A, a highlight that appears around the object 120A, and/or another indicator associated with the object 120A (e.g., the first XR augment 140 is illustrated as a box that appears to surround the object 120A in FIG. 1B). In some embodiments, the XR augment directly outlines the object (e.g., without including surrounding portions of the field-of-view 100 of the user 105).

FIGS. 1C-1D illustrate the field-of-view 100 when the user 105 performs a first eye movement and changes the focus of their gaze 130 to the first XR augment 140 displayed by the head-wearable device 110, in accordance with some embodiments. The head-wearable device 110 detects the first eye movement and, based on the detection, determines a location of the focus of the user's gaze 130 within the field-of-view 100 of the user 105. In some embodiments, the first eye movement and/or the focus of the user's gaze 130 is detected by an eye-tracking camera and/or an IMU of the head-wearable device 110. In accordance with a determination that the focus of the user's gaze 130 is at the first portion of the field-of-view 100, which includes the object 120A, the head-wearable device 110 determines that the user 105 has selected the object 120A (and/or the first XR augment 140). In some embodiments, the head-wearable device 110, in response to an additional determination that the focus of the user's gaze 130 is at the first portion of the field-of-view 100 for a first predetermined period of time (e.g., 2 seconds), determines that the user 105 has selected the object 120A (and/or the first XR augment 140). Alternatively, or in additions, in some embodiments, the head-wearable device 110, determines that the user 105 selected the object 120A (and/or the first XR augment 140) in accordance with a determination that the user 105 performed a hand gesture. In some embodiments, in response to the determination that the user 105 has selected the object 120A (and/or the first XR augment 140), the head-wearable device 110 presents an audio cue to the user 105. In some embodiments, the audio cue includes a description of the object 120A (e.g., “You have selected a globe”).

In response to the determination that the user 105 has selected the object 120A (and/or the first XR augment 140), the head-wearable device 110 displays a second XR augment 150 and ceases to display the first XR augment 140. The second XR augment 150 is presented over a second portion of the field-of-view 100 (e.g., a bottom-right portion of the field-of-view 100, as illustrated in FIG. 1D). The second XR augment 150 includes one or more focus-action selectable elements (e.g., four focus-action selectable elements “VIEW”, “SHOP”, “SEARCH”, and “INFO”, as illustrated in FIG. 1D), and each focus-action selectable element is associated with a respective object-specific action (e.g., an option to view an XR representation of the globe 120A, an option to shop for the globe 120A, an option to perform an Internet search for the globe 120A, and an option to view information about the globe 120A).

FIG. 1E illustrates the user 105 interacting with the second XR augment 150, in accordance with some embodiments. In some embodiments, the user 105 can interact with the second XR augment 150 by changing of the focus of their gaze 130 to the one or more focus-action selectable elements (e.g., moving their eyes to a particular focus-action selectable elements). As described above, the head-wearable device 110 determines the change of the focus of their gaze 130 based on the user's eye movements. The change of the focus of their gaze 130 selects a focus-action selectable element and the head-wearable device causes performance of a respective object-specific action associated with the selected focus-action selectable element. For example, if the head-wearable device determines that the focus of the user's gaze 130 is at the “SHOP” focus-action selectable element, the head-wearable device 110 displays an online-shopping interface associated with the globe 120A.

FIGS. 1F-1G illustrate the field-of-view 100 when the user 105 performs a second eye movement and moves the focus of their gaze 130 off of the second portion of the field-of-view 100 to cause the head-wearable device to display a third XR augment 160, in accordance with some embodiments. The head-wearable device 110 detects the second eye movement, and, based on the detection, the head-wearable device 110 determines a second location of the focus of the user's gaze 130. In accordance with a determination that the second location of the focus of the user's gaze 130 is off of the second portion of the field-of-view 100 for a second predetermined period of time, the head-wearable device 110 ceases displaying the second XR augment 150. In some embodiments, the head-wearable device 110 ceases displaying the second XR augment 150 in accordance with a determination that the second location is a predetermined location within the field-of-view 100 (e.g., a rightmost edge of the field-of-view 100 or an outer edge of the user's field-of-view 100, as illustrated in FIG. 1F) for the second predetermined period of time. In some embodiments, in accordance with the determination that the second location of the focus of the user's gaze 130 is at an outer edge of the user's field-of-view 100, the head-wearable device 110 displays the third XR augment 160.

The third XR augment 160 appears over a third portion of the field-of-view 100 (e.g., a top portion of the field-of-view 100, as illustrated in FIG. 1G), and, in some embodiments, the third portion is larger than the first portion and the second portion. The third XR augment 160 includes one or more object-specific selectable elements (e.g., “VIEW”, “SHOP”, “SEARCH”, and “INFO”, as illustrated in FIG. 1G), and each object-specific selectable element is associated with a respective object-specific action (e.g., an option to view an XR representation of the globe 120A, an option to shop for the globe 120A, an option to perform an Internet search for the globe 120A, and an option to view information about the globe 120A). In some embodiments, each object-specific selectable element includes a representation of the object 120A (e.g., as illustrated in FIG. 1G). In some embodiments, at least one object-specific selectable element of the third XR augment 160 is distinct from the one or more focus-action selectable elements of the second XR augment 150.

An example sequence of the user 105 selecting an object 120A by interacting with the head-wearable device 110 is illustrated by FIGS. 1A-1G. As illustrated in FIG. 1B, the user 105 first sees the first XR augment 140 surrounding the globe 120A in their peripheral vision. As illustrated in FIG. 1C, the user 105 then shifts their gaze 130 to focus on the first XR augment 140 and the globe 120A, and the user 105 holds their gaze 130 for the first predetermined period of time. In response to detecting that the user's gaze 130 is focused on the first XR augment 140 and/or the globe 120A for the first predetermined period of time, the head-wearable device 110 stops displaying the first XR augment 140 and displays the second XR augment 150, as illustrated in FIG. 1D. As illustrated in FIG. 1E, the user 105 then shifts their gaze 130 to the second XR augment 150. As illustrated in FIG. 1F, the user 105 then shifts their gaze 130 to the rightmost edge of the field-of-view 100. In response to detecting that the user's gaze 130 is focused on the rightmost edge of the field-of-view 100, the head-wearable device 110 stops displaying the second XR augment 150 and displays the third XR augment 160, as illustrated in FIG. 1G.

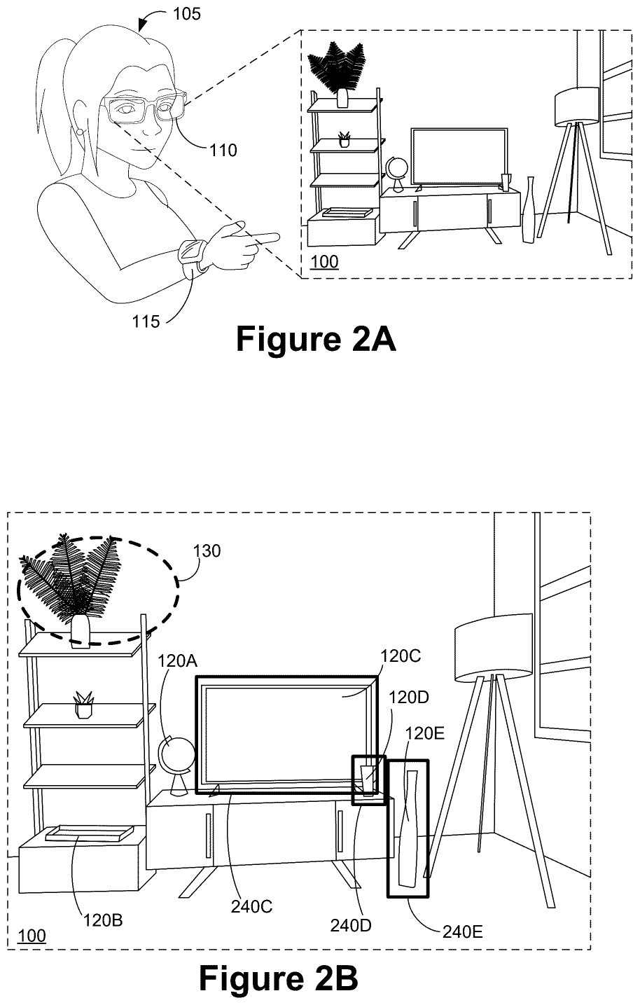

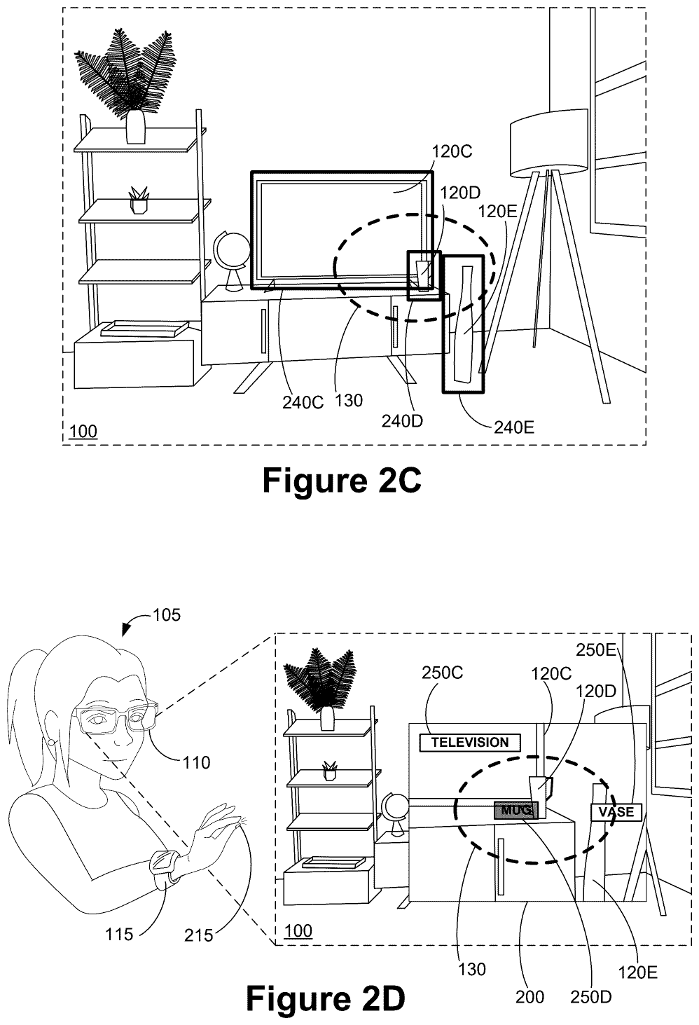

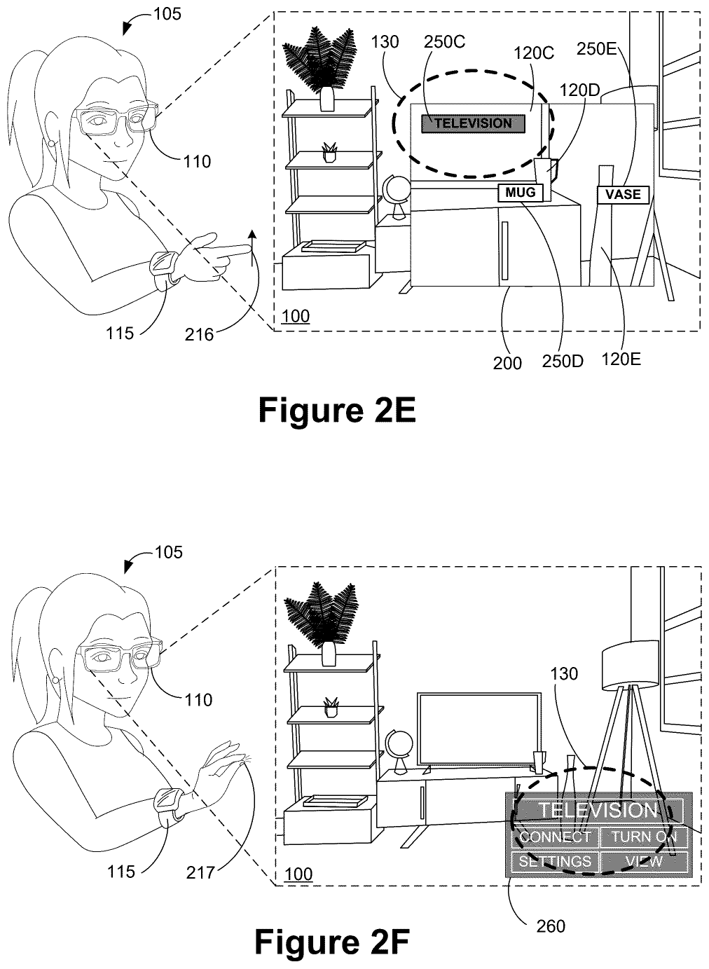

FIGS. 2A-2F illustrate another example embodiment, wherein the user 105 uses the head-wearable device 110 to select one object of one or more objects 120A-120E using the head-wearable device. FIG. 2A illustrates field-of-view of the user 105 wearing the head-wearable device 110 and the wrist-wearable device 115. FIG. 2B illustrates the field-of-view 100 of the user 105 including one or more objects 120C-120E (e.g., the television 120C, the mug 120D, and the vase 120E, as illustrated in FIG. 2B) and at least one XR augment 240C-240E displayed by the head-wearable device (e.g., three XR augments 240C-240E corresponding to the three objects 120C-120E, as illustrated in FIG. 2B), in accordance with some embodiments. Each of the at least one XR augment 240C-240E appears over a respective portion of the field-of-view 100. In some embodiments, each respective portion of the field-of-view 100 is associated with each of the at least one object 120C-120E. In some embodiments, at least one object 120C-120E is an XR object displayed by the head-wearable device 110.

FIGS. 2C-2D illustrate the field-of-view 100 when the user 105 performs a third eye movement and moves the focus of their gaze 130 on at least one of the XR augments 240C-240E, in accordance with some embodiments. In accordance with a determination that the location of the focus of the user's gaze 130 is adjacent to at least two XR augments within a respective portion of the field-of-view 100 (e.g., as illustrated in FIG. 2C) for the first predetermined period of time, the head-wearable device 110 displays a zoomed-in portion 200 of the field-of-view 100. The zoomed-in portion 200 includes the respective portions of the field-of-view 100 and at least one object 120C-120E (e.g., the three objects as illustrated in FIG. 2D). In some embodiments, the zoomed-in portion 200 includes the at least one XR augment 240C-240E. In some embodiments, the zoomed-in portion 200 includes at least one object-tag XR augment 250C-250E (e.g., as illustrated in FIG. 2D). Each of the at least one object-tag XR augment 250C-250E is associated with each of the at least one object 120C-120E, respectively. Alternatively, or in addition, in some embodiments, the head-wearable device 110 displays a zoomed-in portion 200 in response to a zoom-in hand gesture 215 performed by the user 105 (e.g., a finger-tap, as illustrated in FIG. 2D). In some embodiments, the zoom-in hand gesture 215 is detected by the head-wearable device and/or the wrist-wearable device 115.

In some embodiments, the at least one object-tag XR augment 250C-250E each include a written description of the respective object (e.g., a first object-tag XR augment 250C which is associated with the television 120C which states “TELEVISION,” a second object-tag XR augment 250D which is associated with the mug 120D which states “MUG,” and a third object-tag XR augment 250E which is associated with the vase 250E which states “VASE,” as illustrated in FIG. 2D). In some embodiments, the head-wearable device 110 indicates to the user 105 a current (selected) object-tag XR augment (e.g., the second object-tag XR augment 250D is highlighted to show that it is the current object-tag XR augment, as illustrated in FIG. 2D). In some embodiments, the current object-tag XR augment is an object-tag XR augment of the at least one object-tag XR augment 240C-240E which is closest to a center of the focus of the user's gaze 130 when the user 105 performs the third eye movement and/or when the user 105 performs the zoom-in hand gesture 215. For example, as shown in FIG. 2D, the second XR augment 240D is closest to the center of the focus of the gaze 130 when the user 105 performs the third eye movement (as illustrated in FIG. 2C) and/or the zoom-in hand gesture 215, which causes the head-wearable device 110 to display and highlight the second object-tag XR augment 250D.

FIG. 2E illustrates the user 105 interacting with the zoomed-in portion 200, in accordance with some embodiments. FIG. 2E illustrates the user 105 changing the current object-tag XR augment from the second object-tag XR augment 250D to a first object-tag XR augment 250C (e.g., as indicated by the second object-tag XR augment 250D no longer being highlighted, and the first object-tag XR augment 250C now being highlighted, as illustrated in FIG. 2E). In some embodiments, the user 105 changes the current object-tag XR augment by changing the focus of their gaze 130 to one of the at least one object-tag XR augment 250C-250E (e.g., the user 105 shifts the focus of their gaze 130 to the first object-tag XR augment 250C, as illustrated in FIG. 2E). Alternatively, or in addition, in some embodiments, the user 105 changes the current object-tag XR augment by performing a scroll hand gesture 216 (e.g., a finger-up gesture 216, as illustrated in FIG. 2E). In some embodiments, in response to the user 105 changing the current object-tag XR augment from the second object-tag XR augment 250D to the first object-tag XR augment 250C, the head-wearable device 110 presents a second audio cue to the user 105. In some embodiments, the second audio cue includes a description of the first object 120C (e.g., “You have selected a television”).

FIG. 2F illustrates the user 105 selecting the current object-tag XR augment, in accordance with some embodiments. In some embodiments, the user 105 selects the current object-tag XR augment by performing a select hand gesture 217 (e.g., a second finger tap 217, as illustrated in FIG. 2F). In some embodiments, the user 105 selects the current object-tag XR augment by maintaining the focus of their gaze 130 on the current object-tag XR augment for a third predetermined period of time (e.g., five seconds). In accordance with a determination that the user 105 has selected the current object-tag XR augment, the head-wearable device 110 displays an additional XR augment 260 (similar to the XR augment 160 described above in reference to FIGS. 1A-1G) that is associated with the current object-tag XR element. In some embodiments, the additional XR augment 260 includes one or more focus-action selectable elements, and each focus-action selectable element is associated with a respective object-specific action.

An example sequence of the user 105 selecting one object of a plurality of objects 120A-120E by interacting with the head-wearable device 110 is illustrated by FIGS. 2A-2F. As illustrated in FIG. 2B, the head-wearable device 110 displays three XR augments 240C-240E within the field-of-view 100 of the user 105, and each of the three XR augments 240C-240E appears to surround the television 120C, the mug 120D, and the vase 120E, respectively. FIG. 2C illustrates the user 105 moving the focus of their gaze 130 to the three XR augments 240C-240E. FIG. 2D illustrates the user 105 performing the zoom-in hand gesture 215, which causes the head-wearable device 110 to display the zoomed-in portion 200. The zoomed-in portion includes a portion of the field-of-view 100 where the focus of the user's gaze 130 was when the user 105 performed the zoom-in hand gesture 215. The head-wearable device 110 also displays three object-tag XR augments 250C-250E, and each of the three object-tag XR augments 250C-250E is associated with a respective object 120C-120E. Each of the three object-tag XR augments 250C-250E includes a written description of their respective object 120C-120E. The second object-tag XR augment 250D is the current object-tag XR augment because the second object-tag XR augment 240D is the object-tag XR augment of the three object-tag XR augments 240C-240E which was closest to a center of the focus of the user's gaze 130 when the user 105 performed the zoom-in hand gesture 215. The second object-tag XR augment 250D is highlighted to indicate that it is the current object-tag XR augment. FIG. 2E illustrates the user 105 performing the scroll hand gesture 216 to change the current object-tag XR augment from the second object-tag XR augment 250D to the first object-tag XR augment 250C. FIG. 2F illustrates the user 105 performing the select hand gesture 217 to select the current object-tag XR augment, which causes the head-wearable device 110 to display the additional XR augment 260 that is associated with the television 120C.

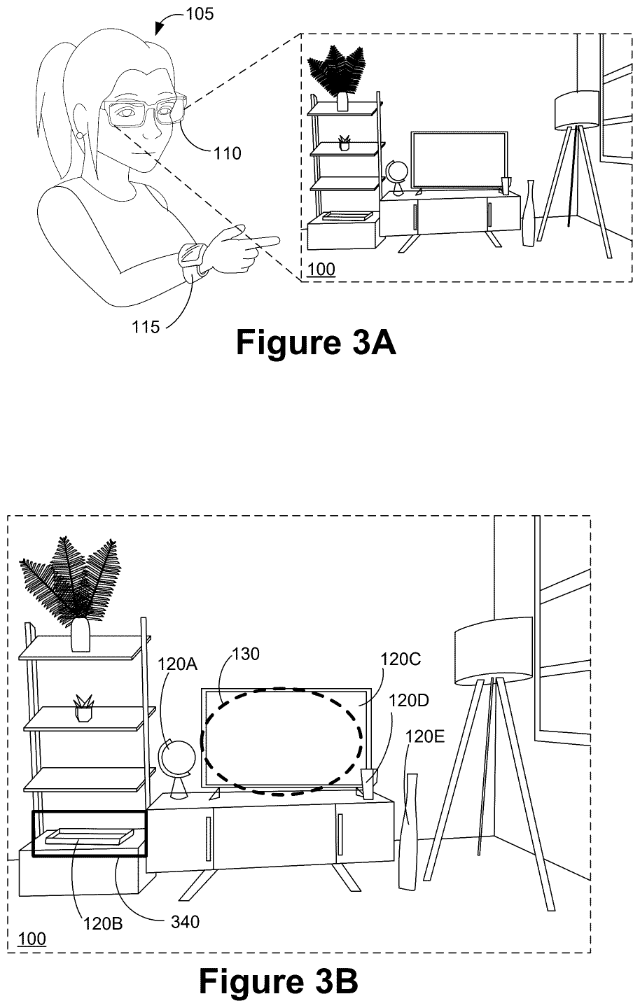

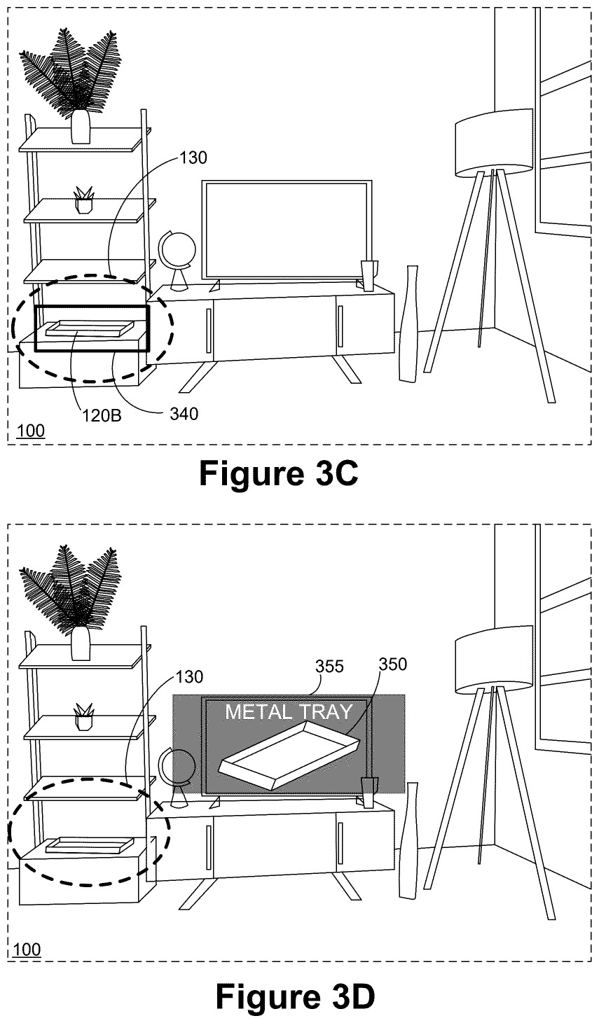

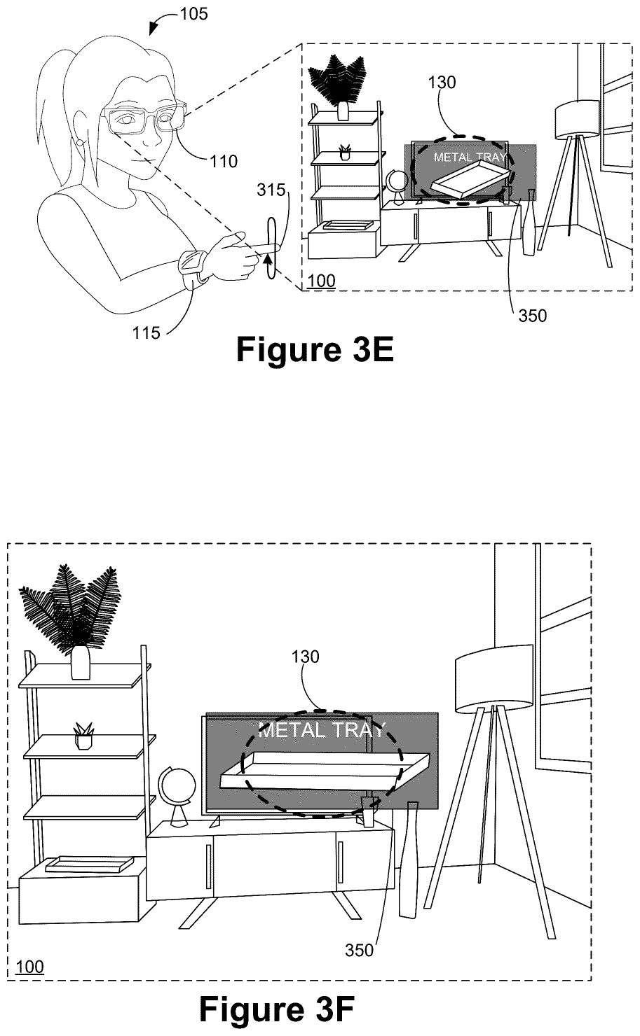

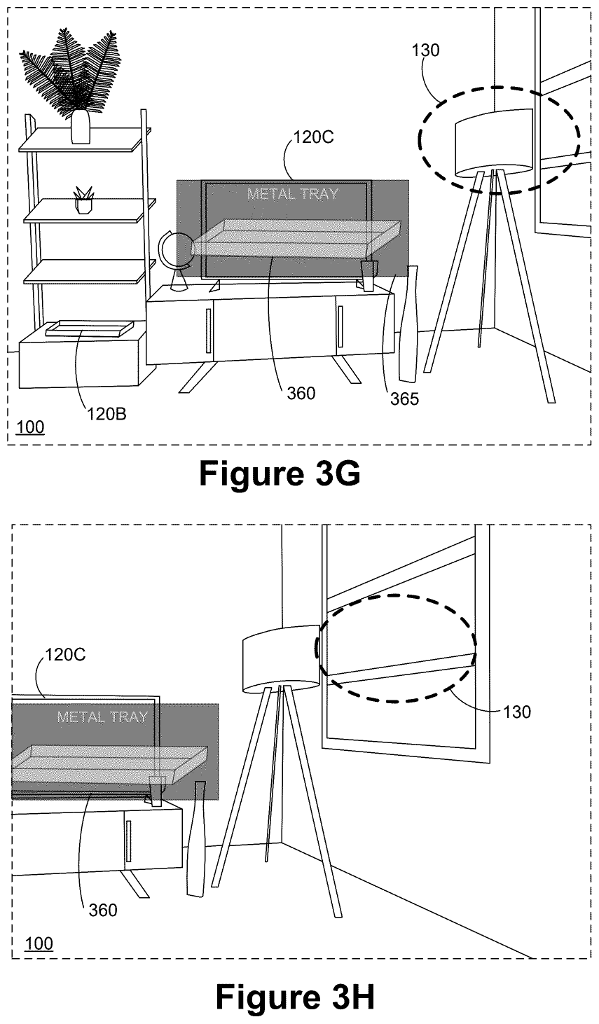

FIGS. 3A-3H illustrate an example head-wearable device 110 for interacting with an XR representation of an object, in accordance with some embodiments. FIG. 3A illustrates the user 105 wearing the head-wearable device 110 and the wrist-wearable device 115 interacting with an XR representation of an object. FIG. 3B illustrates the field-of-view 100 of the user 105 including another object 120B of the at least one object 120A-120E (e.g., the tray 120B, as illustrated in FIG. 3B) and another XR augment 340. The other XR augment 340 appears over another portion of the field-of-view 100 that is associated with the other object 120B. In some embodiments, the other object 120B is an XR object displayed by the head-wearable device 110.

FIGS. 3C-3D illustrate the field-of-view 100 when the user performs a fourth eye movement and changes the focus of their gaze 130 to the other XR augment 340, in accordance with some embodiments. In accordance with a determination that the location of the focus of the user's gaze 130 corresponds with the other portion of the field-of-view 100 that is associated with the other object 120B and/or the other XR augment 340 while the other XR augment 340 is displayed (e.g., as illustrated in FIG. 3C), the head-wearable device 110 determines that the user 105 has selected the other XR augment 340. In some embodiments, the head-wearable device 110 determines that the user 105 has selected the other XR augment 340 in response to an additional determination that the focus of the user's gaze 130 corresponds with the other portion of the field-of-view 100 for another predetermined period of time (e.g., 2 seconds). In some embodiments, the head-wearable device 110 determines that the user 105 has selected the other XR augment 340 in accordance with an additional determination that the user 105 has performed another hand gesture.

In some embodiments, in response to the determination that the user 105 has selected the other XR augment 340, the head-wearable device presents a third audio cue to the user 105. In some embodiments, the second audio cue includes a description of the other object 120B (e.g., “You have selected a tray”). In response to the determination that the user 105 has selected the other XR augment 340, the head-wearable device 110 ceases displaying the other XR augment 340 and displays a detailed XR augment 355 which includes an XR representation 350 of the other object 120B. In some embodiments, the XR representation 350 includes at least one of a 3-dimensional (3D) representation of the other object 120B, the other object 120B (as captured by the head-wearable device 110), a text description of the other object 120B, and/or a transparent representation of the other object 120B (e.g., the XR representation 350 includes a 3D representation of the tray 120B and a text description of the tray 120B, as illustrated in FIG. 3D). In some embodiments, the XR representation 350 appears over the other portion of the field-of-view 100 and/or a first different portion of the field-of-view 100 (e.g., FIG. 3D illustrates the XR representation 350 appearing over the first different portion of the field-of-view 100 that is located at the center of the field-of-view 100).

FIGS. 3E-3F illustrate the user 105 interacting with the XR representation 340, in accordance with some embodiments. FIG. 3E illustrates the head-wearable device 110 displaying the XR representation 350 from a first perspective. In some embodiments, the user 105 changes a perspective of the XR representation 350 between one or more predetermined perspectives (e.g., rotated 90 degrees, 180 degrees, or 270 degrees from the first perspective), and/or the user 105 changes the perspective of the XR representation 350 continuously (e.g., rotated any degree from the first perspective). FIGS. 3E-3F illustrate the user 105 performing a rotate hand gesture 315 (e.g., a finger-spin gesture, as illustrated in FIG. 3E), and, in accordance with a determination that the user 105 performed the rotate hand gesture 315, the head-wearable device 110 displays the XR representation 350 from a second perspective (e.g., as illustrated in FIGS. 3F). In some embodiments, the first perspective changes to the second perspective in accordance with an additional determination that the focus of the user's gaze 130 is on the XR representation 350 when the user 105 performs the rotate hand gesture 315, as illustrated in FIG. 3E. FIG. 3F illustrates the XR representation 350 from the second perspective that is a 90-degree rotation from the first perspective illustrated in FIG. 3E.

FIG. 3G illustrates the field-of-view 100 when the user 105 performs a fifth eye movement and moves the focus of their gaze 130 off of the XR representation 340. In accordance with a determination that the user 105 has performed the fifth eye movement and changed the focus of their gaze 130 off of the XR representation 350 for a fourth predetermined period of time (e.g., half of a second), the head-wearable device 110 ceases displaying the XR representation 350 and displays a peripheral XR augment 365 which includes a peripheral XR representation 360 of the other object 120B. In some embodiments, the peripheral XR representation 360 appears over the other portion and/or the first different portion of the field-of-view 100. In some embodiments, the peripheral XR representation 360 appears over a second different portion of the field-of-view 100, distinct from the other portion and the first different portion (e.g., a bottom-right corner of the field-of-view 100). The peripheral XR representation 360 includes at least a representation of the other object 120B, a text description of the other object 120B, a transparent representation of the other object 120B, a color of the other object 120B, and/or a shape of the other object 120B (e.g., the peripheral XR representation 360 includes a transparent representation of the other object 120B and a text description of the other object 120B, as illustrated in FIG. 3G). In accordance with a determination that the user 105 has performed a sixth eye movement and moves the focus of their gaze 130 on to the peripheral XR representation 360, the head-wearable device 110 stops displaying the peripheral XR representation 360 and displays the XR representation 350 again. In some embodiments, the XR representation 350 appears over the other portion and/or the first different portion of the field-of-view 100.

FIG. 3H illustrates the user 105 changing the field-of-view 100 (e.g., by moving their head and/or their body) such that the other object 120B is no longer within field-of-view 100, in accordance with some embodiments. In some embodiments, in accordance with a determination that the other object 120B is no longer within the field-of-view, the head-wearable device 110 ceases displaying the peripheral XR representation. In some embodiments, in accordance with a determination that the other object 120B is no longer within the field-of-view, the head-wearable device 110 continues to display the peripheral XR representation 360 such that it appears over a location in an environment of the user 105 that is associated with the other portion and/or the first different portion of the field-of-view 100 before the changing of the field-of-view 100 (e.g., as illustrated in FIG. 3G, the peripheral XR representation 360 appears over the television 120C, and when the user 105 changes the field-of-view 100, as illustrated in FIG. 3H, the peripheral XR representation 360 continues to appear over the television 120C). In some embodiments, the peripheral XR representation 360 continues to appear over the other portion, the first different portion, and/or the second different portion of the field-of-view 100. In accordance with a determination that the user 105 has performed a seventh eye movement and changed the focus of their gaze 130 on to the peripheral XR representation 360, the head-wearable device 110 stops displaying the peripheral XR representation 360 and displays the XR representation 350 again.

An example sequence of the user 105 interacting with the XR representation 340 of the other object 120B. As illustrated in FIG. 3B, the head-wearable device 110 displays the other XR augment 340 within the field-of-view 100 of the user 105, and the other XR augment 340 appears to surround the tray 120B. FIG. 3C illustrates the user 105 moving the focus of their gaze 130 on to the other XR augment 340. After the user 105 maintains the focus of their gaze 130 on the other XR augment for the other predetermined period of time, the head-wearable device 110 stops displaying the other XR augment 340 and displays the XR representation 350, as illustrated in FIG. 3D. FIGS. 3E-3F illustrate the user 105 performing a rotate hand gesture 315 to change the perspective of the XR representation 350. FIG. 3G illustrates the user 105 moving the focus of their gaze 130 off of the XR representation 350, and the head-wearable device 110 replaces the XR representation 350 with the peripheral XR representation 360. FIG. 3H illustrates the user 105 changing the field-of-view 100 by turning their head. In response to a determination that the field-of-view 100 has changed, the head-wearable device 110 changes a location of the peripheral XR representation 360 within the field-of-view 100, such that the peripheral XR representation continues to appear over the television 120C.

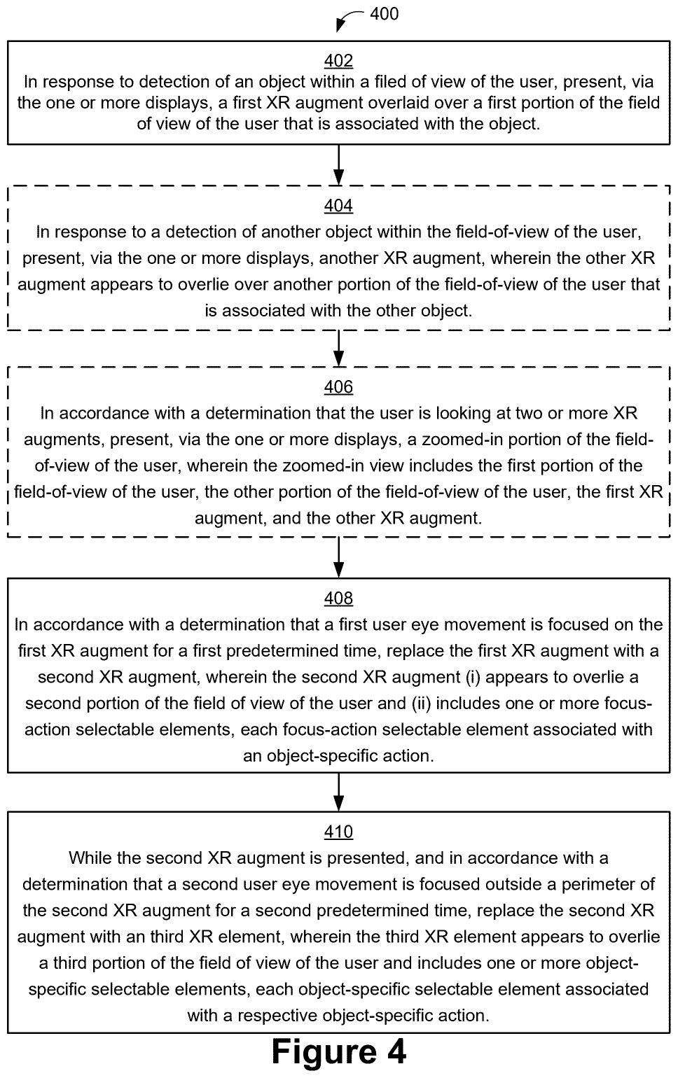

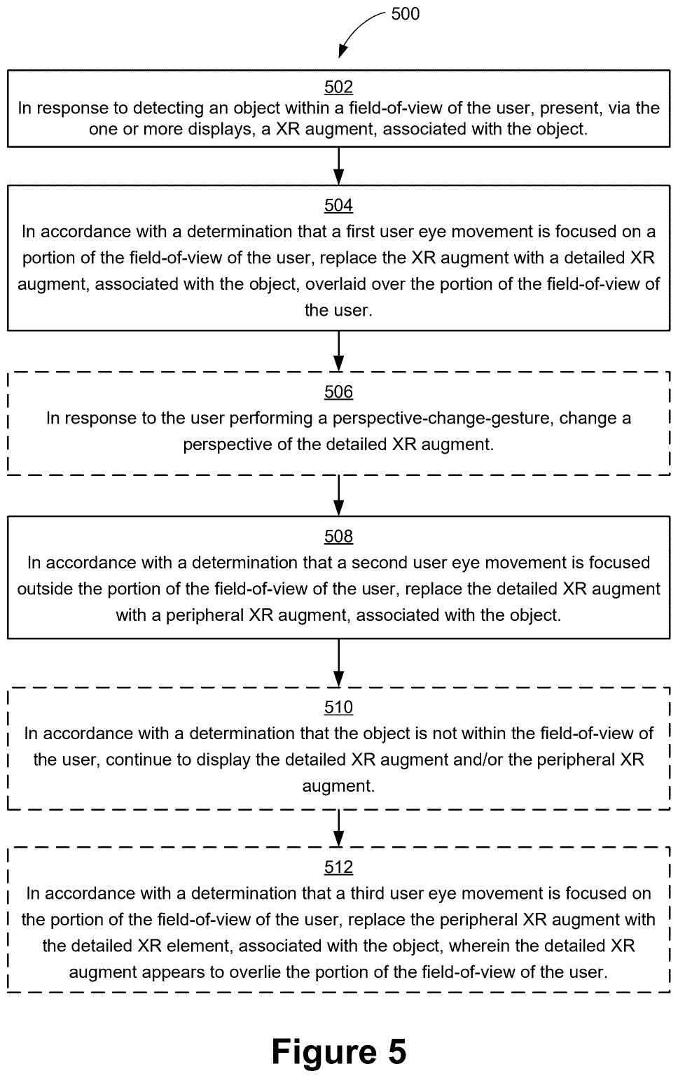

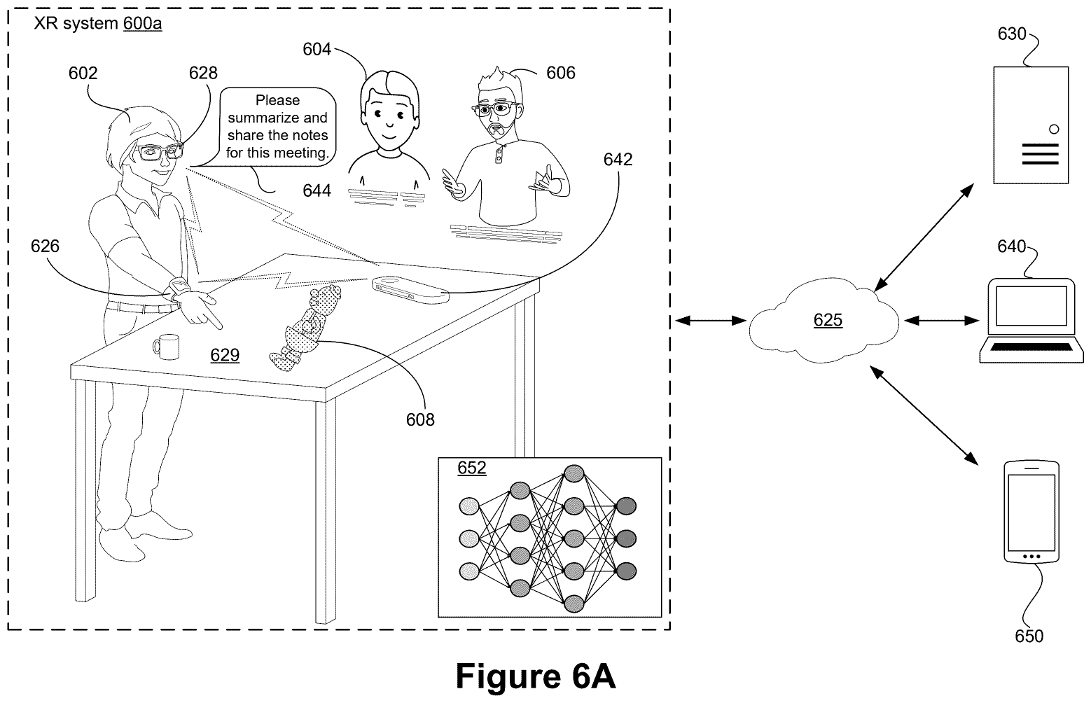

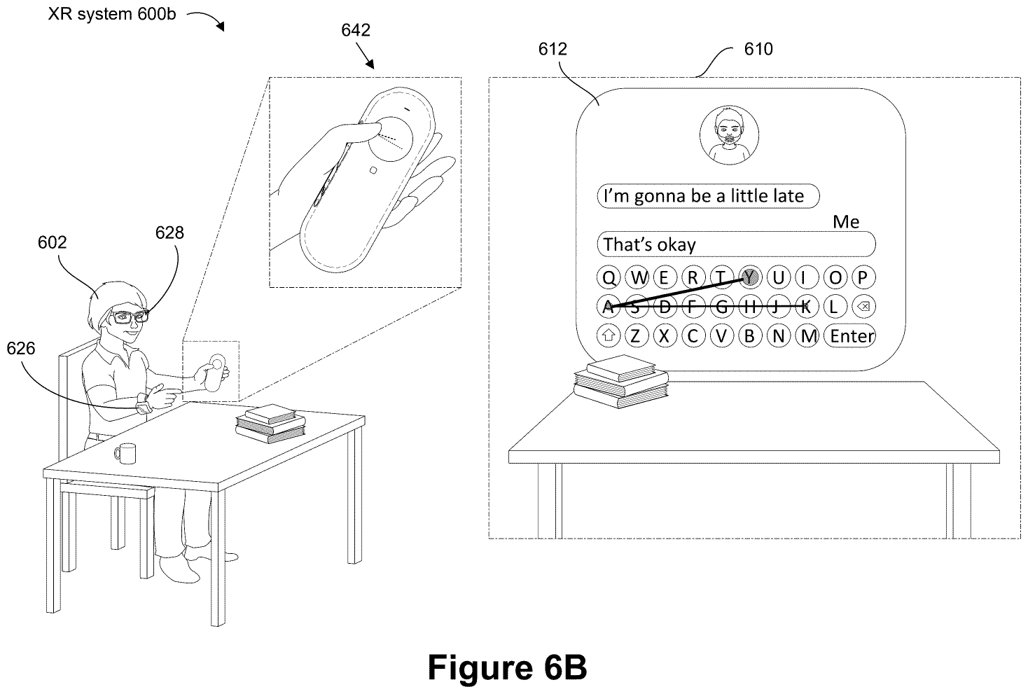

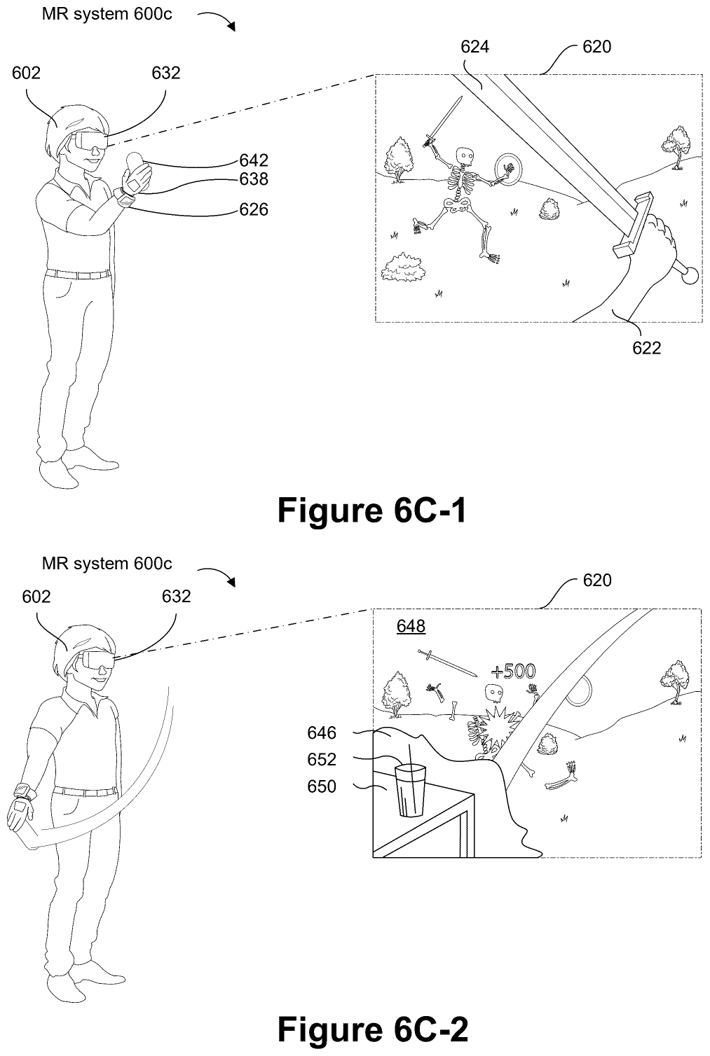

FIGS. 4 and 5 illustrate flow diagrams of methods for interacting with objects via a head-wearable device, in accordance with some embodiments. Operations (e.g., steps) of the methods 400 and 500 can be performed by one or more processors (e.g., central processing unit and/or MCU) of a system (e.g., XR systems 600a-600c). At least some of the operations shown in FIGS. 4 and 5 correspond to instructions stored in a computer memory or computer-readable storage medium (e.g., storage, RAM, and/or memory). Operations of the methods 400 and 500 can be performed by a single device (e.g., AR device 628 or MR device 632) alone or in conjunction with one or more processors and/or hardware components of another communicatively coupled device (e.g., HIPD 642, a wrist-wearable device 626, a mobile devices 650, and/or other devices described below in reference to FIGS. 6A-6C-2) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

FIG. 4 illustrates a flow diagram of a method of selecting objects with the display of the head-wearable device 110, in accordance with some embodiments. The method 400 includes, in response to a detection of an object (a physical object or an AR object) within a field-of-view of a user, presenting, via one or more displays, a XR augment overlaid over a first portion of the field-of-view of the user that associated with the object 402. In some embodiments, the method 400 further includes, in accordance with a detection of another object within the field-of-view of the user, presenting, via the one or more displays, another XR augment, wherein the other XR augment appears to overlie over another portion of the field-of-view of the user that is associated with the other object 404. In some embodiments, the method 400 further includes, in accordance with a determination that the user is looking at two or more XR augments, presenting, via the one or more displays, a zoomed-in portion of the field-of-view of the user, wherein the zoomed-in view includes the first portion of the field-of-view of the user, the other portion of the field-of-view of the user, the first XR augment, and the other XR augment 406. The method 400 further includes, in accordance with a determination that a first user eye movement (e.g., an eye saccade) is focused on the first XR augment for a first predetermined time, replacing the first XR augment with a second XR augment, wherein the second XR augment (i) appears to overlie a second portion of the field-of-view of the user and (ii) includes one or more focus-action selectable elements, each focus-action selectable element associated with an object-specific action 408. The method 400 further includes, while the second XR augment is presented and in accordance with a determination that a second user eye movement is focused outside a perimeter of the second XR augment for a second predetermined time, replacing the second XR augment with an third XR element, wherein the third XR element appears to overlie a third portion of the field-of-view of the user and includes one or more object-specific selectable elements, each object-specific selectable element associated with a respective object-specific action 410.

FIG. 5 illustrates a flow diagram of a method for interacting with an XR representation of an object with the display of the head-wearable device 110, in accordance with some embodiments. The method 500 includes, in response to detecting an object within a field-of-view of the user, presenting, via the one or more displays, an XR augment, associated with the object 502. The method 500 further includes, in accordance with a determination that a first user eye movement is focused on a portion of the field-of-view of the user, replacing the XR augment with a detailed XR augment, associated with the object, wherein the detailed XR augment appears to overlie the portion of the field-of-view of the user 504. In some embodiments, the method 500 further includes, in response to the user performing a perspective-change-gesture, (e.g., spinning their finger) changing a perspective of the detailed XR augment. The method 500 further includes in accordance with a determination that a second user eye movement is focused outside the portion of the field-of-view of the user, replacing the detailed XR augment with a peripheral XR augment, associated with the object 508. In some embodiments, the method 500 further includes, in accordance with a determination that the object is not within the field-of-view of the user, continuing to display the detailed graphical focus element and/or the peripheral graphical focus element 510. In some embodiments, the method 500 further includes, in accordance with a determination that a third user eye movement is focused on the portion of the field-of-view of the user, replacing the peripheral XR augment with the detailed XR element, associated with the object, wherein the detailed XR augment appears to overlie the portion of the field-of-view of the user 512.

(A1) In accordance with some embodiments, a head-wearable device comprises one or more displays, one or more imaging devices, and one or more programs. The one or more programs are stored in memory and are configured to be executed by one or more processors while the head-wearable device is worn by a user. The one or more programs include instructions for, in response to a detection of an object within a field-of-view of the user (e.g., a field-of-view that includes both physical and AR objects), presenting, via the one or more displays, a first XR augment overlaid over a first portion of the field-of-view of the user that is associated with the object. The one or more programs further include instructions for, in accordance with a determination that a first user eye movement (e.g., a saccade) is focused on the first XR augment for a first predetermined time, replacing the first XR augment with a second XR augment. The second XR augment appears to overlie a second portion (larger than the first portion in some embodiments) of the field-of-view of the user and includes one or more focus-action selectable elements. Each focus-action selectable element is associated with an object-specific action. The one or more programs further include instructions for, while the second XR augment is presented, in accordance with a determination that a second user eye movement is focused outside a perimeter of the second XR augment for a second predetermined time, replacing the second XR augment with a third XR element. The third XR element appears to overlie a third portion (larger than the second portion in some embodiments) of the field-of-view of the user and includes one or more object-specific selectable elements. Each object-specific selectable element is associated with a respective object-specific action. For example, FIG. 1A illustrates the head-wearable 110 device comprising one or more displays, one or more imaging devices, and one or more programs. FIG. 1B illustrates the head-wearable device 110, in response to a detection of a globe 120A within a field-of-view 100 of the user 105, presenting a first XR augment 140 overlaid over a first portion of the field-of-view 100 of the user 105 that is associated with the globe 120A. FIGS. 1C-1D illustrate the head-wearable device 110, in accordance with a determination that a first user eye movement is focused on the first XR augment 140 for a first predetermined time, replacing the first XR augment 140 with a second XR augment 150. FIG. 1D illustrates the second XR augment 150 appearing to overlie a second portion of the field-of-view 100 of the user 105 and includes one or more focus-action selectable elements (“VIEW”, “SHOP”, “SEARCH”, and “INFO”). FIGS. 1E-1F illustrate the head-wearable device 110, in accordance with a determination that a second user eye movement is focused outside a perimeter of the second XR augment 150 for a second predetermined time, replacing the second XR augment 150 with a third XR element 160. The third XR element 160 appears to overlie a third portion of the field-of-view 100 of the user 105 and includes one or more object-specific selectable elements (“VIEW”, “SHOP”, “SEARCH”, and “INFO”).

(A2) In some embodiments of A1, the one or more programs further include instructions for, in response to a detection of another object within the field-of-view of the user, presenting, via the one or more displays, another XR augment. The other XR augment appears to overlie over another portion of the field-of-view of the user that is associated with the other object. For example, FIG. 2B illustrates the head-wearable device 110, in response to a detection of three objects 120C-120E (a television 120C, a mug 120D, and a vase 140E) within the field-of-view 100 of the user 105, presenting, three XR augments 240C-240E. The three XR augments 240C-240E appear to overlie three portions of the field-of-view 100 of the user 105 that are associated with the three objects 120C-120E, respectively.

(A3) In some embodiments of A1-A2, the object and the other object are ranked based on proximity to a location of the first user eye movement.

(A4) In some embodiments of A1-A3, the one or more programs further include instructions for, in accordance with a determination that a third user eye movement is focused on the first XR augment and the other XR augment, presenting, via the one or more displays, a zoomed-in portion of the field-of-view of the user. The zoomed-in portion includes the first portion of the field-of-view of the user, the other portion of the field-of-view of the user, the object, and the other object. For example, FIG. 3D illustrates the head-wearable device 110, in accordance with a determination that a third user eye movement is focused on the three XR augments 120C-120E, presenting a zoomed-in portion 200 of the field-of-view of the user 100, wherein the zoomed-in portion 200 includes the three portions of the field-of-view of the user and the three objects 120C-120E.

(A5) In some embodiments of A1-A4, the presenting the zoomed-in portion of the field-of-view of the user includes replacing the XR augment and the other XR augment with a first object-tag augment, associated with the object, and a second object-tag augment, associated with the other object, respectively. For example, FIGS. 2C-2D illustrate the head-wearable device 110 presenting the zoomed-in portion 200 of the field-of-view 100 of the user 105 includes replacing the three XR augments 240C-240E with three first object-tag augments 250C-250E, which are associated with the three objects 120C-120E, respectively.

(A6) In some embodiments of A1-A5, the presenting the zoomed-in portion of the field-of-view of the user further includes indicating, to the user, that the first object-tag augment is currently selected (e.g., by highlighting the object-tag element), and, in response to the user performing a scroll gesture, (e.g., swiping their finger) indicating, to the user, that the second object-tag augment is currently selected. The presenting the zoomed-in portion of the field-of-view of the user further includes, in response to the user performing a select gesture (e.g., pinching with their finger), replacing the zoomed-in portion of the field-of-view with an additional XR augment. The additional XR augment appears to overlie the second portion of the field-of-view of the user and includes one or more additional object-specific selectable elements. Each additional object-specific selectable element is associated with a respective additional object-specific action. For example, FIG. 2D-2F illustrate the head-wearable device 110 indicating, to the user 105, that the first object-tag augment 250D is currently selected (e.g., by highlighting the object-tag element 250D), and, in response to the user performing a scroll gesture 216, indicating, to the user, that the second object-tag augment 205C is currently selected. The head-wearable device 110 further, in response to the user 105 performing a select gesture 217, replacing the zoomed-in portion 200 of the field-of-view 100 with an additional XR augment 150C. The additional XR augment 150 appears to overlie the second portion of the field-of-view 100 of the user 105 and includes one or more additional object-specific selectable elements (“CONNECT”, “TURN ON”, “SETTINGS”, and “VIEW”).

(A7) In some embodiments of A1-A6, the presenting the zoomed-in portion of the field-of-view of the user is in response to the user performing a zoom gesture (e.g., a pinch-and-expand gesture). For example, FIG. 2D illustrates the zoomed-in portion 200 of the field-of-view 100 of the user 105 being presented in response to the user performing a zoom gesture 215.

(A8) In some embodiments of A1-A7, the replacing the first XR augment with the second XR augment is in response to the user performing a point-gesture. (e.g., the user pointing at the graphical focus element).

(A9) In some embodiments of A1-A8, each object-specific selectable element includes a representation of the object. For example, FIG. 1G illustrates each object-specific selectable element of the third XR augment 160 including a representation of the globe 120A.

(A10) In some embodiments of A1-A9, the head-wearable device further comprises at least one of an eye-tracking camera and an IMU, and the first user eye movement and the second user eye movement are detected by the at least one of the eye-tracking camera and the IMU.

(A11) In some embodiments of A1-A10, the replacing of the first XR augment with the second XR augment is in response to the user performing a point gesture (e.g., the user pointing at the first XR augment).

(A12) In some embodiments of A1-A11, the object is an XR object, presented by the head-wearable device.

(A13) In some embodiments of A1-A12, the head-wearable device is a pair of XR glasses. For example, FIG. 1A illustrate the head-wearable device 110 as a pair of XR glasses.

(B1) In accordance with some embodiments, a head-wearable device comprises one or more displays, one or more imaging devices, and one or more programs. The one or more programs are stored in memory and configured to be executed by one or more processors while the head-wearable device is worn by a user. The one or more programs include instructions for, in response to detecting an object within a field-of-view of the user, presenting, via the one or more displays, an XR augment, associated with the object. The one or more programs further include instructions for, in accordance with a determination that a first user eye movement is focused on a portion of the field-of-view of the user that is associated with the object, replacing the XR augment with a detailed XR augment, associated with the object. The detailed XR augment appears to overlie another portion of the field-of-view of the user. The one or more programs further include instructions for, in accordance with a determination that a second user eye movement is focused outside the portion of the field-of-view of the user, replacing the detailed XR augment with a peripheral XR augment, associated with the object. For example, FIG. 3A illustrates the head-wearable 110 device comprising one or more displays, one or more imaging devices, and one or more programs. FIG. 3B illustrates the head-wearable device 110, in response to detecting a tray 120B within a field-of-view 100 of the user 105, presenting, via the one or more displays, an XR augment 340, associated with the tray 120B. FIGS. 3C-3D illustrate the head-wearable device 110, in accordance with a determination that a first user eye movement is focused on a portion of the field-of-view 100 of the user 105 that is associated with the tray 120B, replacing the XR augment 340 with a detailed XR augment 350, associated with the tray 120B. FIG. 3D illustrates the detailed XR augment 350 appearing to overlie another portion of the field-of-view 100 of the user 105. FIGS. 3F-3G illustrates the head-wearable device 110, in accordance with a determination that a second user eye movement is focused outside the portion of the field-of-view 100 of the user 105, replacing the detailed XR augment 350 with a peripheral XR augment 360, associated with the tray 120B.

(B2) In some embodiments of B1, the one or more programs further include instructions for, in accordance with a determination that a third user eye movement is focused on the portion of the field-of-view of the user, replacing the peripheral XR augment with the detailed XR element, associated with the object, wherein the detailed XR augment appears to overlie the portion of the field-of-view of the user.

(B3) In some embodiments of B1-B2, the one or more programs further include instructions for, in response to the user performing a perspective-change-gesture (e.g., spinning their finger), changing a perspective of the detailed XR augment. For example, FIGS. 3E-3F illustrate the head-wearable device 110, in response to the user performing a perspective-change-gesture 315, changing a perspective of the detailed XR augment 350.

(B4) In some embodiments of B1-B3, the one or more programs further include instructions for, in accordance with a determination that the field-of-view of the user has changed to a second field-of-view, (e.g., the user moves their head) wherein the object is not within the second field-of-view, continue to display the peripheral XR augment. For example, FIGS. 3G-3H illustrate the head-wearable device 110, in accordance with a determination that the field-of-view 100 of the user 105 has changed to a second field-of-view, wherein the tray 120B is not within the second field-of-view, continuing to display the peripheral XR augment 360.

(B5) In some embodiments of B1-B4, the replacing the XR augment with the detailed XR augment is in response to the user performing a point-gesture.

(B6) In some embodiments of B1-B5, the detailed XR augment includes a first representation of the object, and the peripheral XR augment includes a second representation of the object.

(B7) In some embodiments of B1-B6, the first representation of the object is a 3D representation of the object. For example, FIGS. 3D-3F illustrate the detailed XR augment 350 including the first representation of the tray 120B as a 3D representation of the tray 120B.

(B8) In some embodiments of B1-B7, the second representation of the object is at least one of: a 2D representation of the object, a text description of the object, a color of the object, a shape of the object, and a transparent 3D representation of the object. For example, FIGS. 3G-3H illustrate the peripheral XR augment 360 including the second representation of the tray 120B as a text description of the tray 120B and a transparent 3D representation of the tray 120B.

(B9) In some embodiments of B1-B8, the head-wearable device further comprises one or more speakers, and the one or more programs further include instructions for, in accordance with the determination that the first user eye movement is focused on the portion of the field-of-view of the user that is associated with the object, presenting an audio cue to the user. The audio cue includes a description of the object.

(B10) In some embodiments of B1-B9, the head-wearable device further comprising at least one of an eye-tracking camera and an IMU, and the first user eye movement and the second user eye movement are detected by the at least one of the eye-tracking camera and the IMU.

(B11) In some embodiments of B1-B10, the object is an XR object, presented by the head-wearable device.

(B12) In some embodiments of B1-B11, the head-wearable device is a pair of XR glasses. For example, FIG. 3A illustrates the head-wearable device 110 as a pair of XR glasses.

(C1) In accordance with some embodiments, a system that includes one or more of a head-wearable device, a wrist-wearable device, and a handheld-intermediary processing device, and the system is configured to perform operations corresponding to any of A1-A13.

(D1) In accordance with some embodiments, a non-transitory computer readable storage medium including instructions that, when executed by a computing device in communication with a head-wearable device, cause the computer device to perform operations corresponding to any of A1-A13.

(E1) In accordance with some embodiments, a method of operating a head-wearable device, including operations that correspond to any of A1-A13.

(F1) In accordance with some embodiments, a system that includes one or more of a head-wearable device, a wrist-wearable device, and a handheld-intermediary processing device, and the system is configured to perform operations corresponding to any of B1-B12.

(G1) In accordance with some embodiments, a non-transitory computer readable storage medium including instructions that, when executed by a computing device in communication with a head-wearable device, cause the computer device to perform operations corresponding to any of B1-B12.

(H1) In accordance with some embodiments, a method of operating a head-wearable device, including operations that correspond to any of B1-B12.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

FIGS. 6A-6C-2, illustrate example XR systems that include AR and MR systems, in accordance with some embodiments. FIG. 6A shows a first XR system 600a and first example user interactions using a wrist-wearable device 626, a head-wearable device (e.g., AR device 628), and/or a HIPD 642. FIG. 6B shows a second XR system 600b and second example user interactions using a wrist-wearable device 626, AR device 628, and/or an HIPD 642. FIGS. 6C-1 and 6C-2 show a third MR system 600c and third example user interactions using a wrist-wearable device 626, a head-wearable device (e.g., an MR device such as a VR device), and/or an HIPD 642. As the skilled artisan will appreciate upon reading the descriptions provided herein, the above-example AR and MR systems (described in detail below) can perform various functions and/or operations.

The wrist-wearable device 626, the head-wearable devices, and/or the HIPD 642 can communicatively couple via a network 625 (e.g., cellular, near field, Wi-Fi, personal area network, wireless LAN). Additionally, the wrist-wearable device 626, the head-wearable device, and/or the HIPD 642 can also communicatively couple with one or more servers 630, computers 640 (e.g., laptops, computers), mobile devices 650 (e.g., smartphones, tablets), and/or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, and/or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, and/or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device 628, and/or the HIPD 642. In addition, the user 602 is also able to directly view physical objects in the environment, such as a physical table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device and/or built-in motion tracking of a user's extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors and/or IMUs built into the wrist-wearable device) and/or AR device 628 (e.g., using one or more image sensors or cameras) to provide a user input. Alternatively, or additionally, the user 602 can provide a user input via one or more touch surfaces of the wrist-wearable device 626, the AR device 628, and/or the HIPD 642, and/or voice commands captured by a microphone of the wrist-wearable device 626, the AR device 628, and/or the HIPD 642. The wrist-wearable device 626, the AR device 628, and/or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures and/or facial expressions. For example, cameras of the wrist-wearable device 626, the AR device 628, and/or the HIPD 642 can track the user 602's eyes for navigating a user interface.

The wrist-wearable device 626, the AR device 628, and/or the HIPD 642 can operate alone or in conjunction to allow the user 602 to interact with the AR environment. In some embodiments, the HIPD 642 is configured to operate as a central hub or control center for the wrist-wearable device 626, the AR device 628, and/or another communicatively coupled device. For example, the user 602 can provide an input to interact with the AR environment at any of the wrist-wearable device 626, the AR device 628, and/or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, and/or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 and/or the AR device 628 operational data corresponding to the performed back-end tasks such that the wrist-wearable device 626 and/or the AR device 628 can perform the front-end tasks. In this way, the HIPD 642, which has more computational resources and greater thermal headroom than the wrist-wearable device 626 and/or the AR device 628, performs computationally intensive tasks and reduces the computer resource utilization and/or power usage of the wrist-wearable device 626 and/or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing and/or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608. Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, and/or the HIPD 642 are coordinated such that the user can use any device to initiate, continue, and/or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact and/or manipulate the virtual object 608. While an AR device 628 is described working with a wrist-wearable device 626, an MR headset can be interacted with in the same way as the AR device 628.

### Integration of Artificial Intelligence with XR Systems

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many different aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language and/or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, and/or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

### Example Augmented Reality Interaction

FIG. 6B shows the user 602 wearing the wrist-wearable device 626 and the AR device 628 and holding the HIPD 642. In the second AR system 600b, the wrist-wearable device 626, the AR device 628, and/or the HIPD 642 are used to receive and/or provide one or more messages to a contact of the user 602. In particular, the wrist-wearable device 626, the AR device 628, and/or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, and/or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by user 602's field-of-view 610). In some embodiments, the application is initiated and can be run on the device (e.g., the wrist-wearable device 626, the AR device 628, and/or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 and/or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, and/or the HIPD 642 to continue and/or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The user 602's gestures performed on the HIPD 642 can be provided and/or displayed on another device. For example, the user 602's swipe gestures performed on the HIPD 642 are displayed on a virtual keyboard of the messaging user interface 612 displayed by the AR device 628.

In some embodiments, the wrist-wearable device 626, the AR device 628, the HIPD 642, and/or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, and/or other communicatively coupled device and provide a user input at the wrist-wearable device 626, the AR device 628, and/or the HIPD 642 to review the notification, and the device detecting the user input can cause an application associated with the notification to be initiated and/or presented at the wrist-wearable device 626, the AR device 628, and/or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, and/or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third AR system 600c, the wrist-wearable device 626, the MR device 632, and/or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, and/or the HIPD 642 detect and coordinate one or more user inputs to allow the user 602 to interact with the VR game.

In some embodiments, the user 602 can provide a user input via the wrist-wearable device 626, the MR device 632, and/or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data and/or image data to detect the user input and provide an accurate representation of the user 602's motion. For example, image sensors (e.g., SLAM cameras or other cameras) of the HIPD 642 can be used to detect a position of the HIPD 642 relative to the user 602's body such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the user 602's movements; and image sensors of the MR device 632 can be used to represent the user 602's body, boundary conditions, or real-world objects within the first MR game environment 620.

In FIG. 6C-2, the user 602 performs a downward swing while holding the HIPD 642. The user 602's downward swing is detected by the wrist-wearable device 626, the MR device 632, and/or the HIPD 642 and a corresponding action is performed in the first MR game environment 620. In some embodiments, the data captured by each device is used to improve the user's experience within the MR environment. For example, sensor data of the wrist-wearable device 626 can be used to determine a speed and/or force at which the downward swing is performed and image sensors of the HIPD 642 and/or the MR device 632 can be used to determine a location of the swing and how it should be represented in the first MR game environment 620, which, in turn, can be used as inputs for the MR environment (e.g., game mechanics, which can use detected speed, force, locations, and/or aspects of the user 602's actions to classify a user's inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the MR game environment 620 is being displayed. In this instance, a reconstruction of the physical environment 646 is displayed in place of a portion of the MR game environment 620 when object(s) in the physical environment are potentially in the path of the user (e.g., a collision with the user and an object in the physical environment are likely). Thus, this example MR game environment 620 includes (i) an immersive VR portion 648 (e.g., an environment that does not have a corollary counterpart in a nearby physical environment) and (ii) a reconstruction of the physical environment 646 (e.g., table 650 and cup 652). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, and/or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the user 602's movements (while holding the HIPD 642) to cause the performance of corresponding actions within the first MR game environment 620. Additionally or alternatively, in some embodiments, operational data (e.g., sensor data, image data, application data, device data, and/or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), and/or hold an HIPD 642 device. In this embodiment, the wrist-wearable device 626, the MR device 632, and/or the smart textile-based garments 638 are used to interact within an MR environment (e.g., any AR or MR system described above in reference to FIGS. 6A-6B). While the MR device 632 presents a representation of an MR game (e.g., second MR game environment 620) to the user 602, the wrist-wearable device 626, the MR device 632, and/or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, and/or the smart textile-based garments 638 that causes an action in a corresponding MR environment. In some embodiments, each device uses respective sensor data and/or image data to detect the user input and provide an accurate representation of the user 602's motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 638 can be used in conjunction with an MR device and/or an HIPD 642.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for case of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 6A-6C-2 provided above are intended to augment the description provided in reference to FIGS. 1A-5. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A head-wearable device, comprising:
one or more displays; and
one or more programs, wherein the one or more programs are stored in memory and configured to be executed by one or more processors, the one or more programs including instructions for:
while the head-wearable device is worn by a user:
in response to a detection of an object within a field-of-view of the user, presenting, via the one or more displays, a first extended reality (XR) augment overlaid over a first portion of the field-of-view of the user that is associated with the object;
in accordance with a determination that a first user eye movement is focused on the first XR augment for a first predetermined time, replacing the first XR augment with a second XR augment, wherein the second XR augment:
appears to overlie a second portion of the field-of-view of the user, and
includes one or more focus-action selectable elements, each focus-action selectable element associated with an object-specific action; and
while the second XR augment is presented, in accordance with a determination that a second user eye movement is focused outside a perimeter of the second XR augment for a second predetermined time, replacing the second XR augment with a third XR augment, wherein the third XR augment:
appears to overlie a third portion of the field-of-view of the user, and
includes one or more object-specific selectable elements, each object-specific selectable element associated with a respective object-specific action.

2. The head-wearable device of claim 1, wherein the one or more programs further include instructions for:
while the head-wearable device is worn by the user:
in response to a detection of another object within the field-of-view of the user, presenting, via the one or more displays, another XR augment, wherein the other XR augment appears to overlie over another portion of the field-of-view of the user that is associated with the other object.

3. The head-wearable device of claim 2, wherein the object and the other object are ranked based on proximity to a location of the first user eye movement.

4. The head-wearable device of claim 2, wherein the one or more programs further include instructions for:
while the head-wearable device is worn by the user:
in accordance with a determination that a third user eye movement is focused on the first XR augment and the other XR augment, presenting, via the one or more displays, a zoomed-in portion of the field-of-view of the user, wherein the zoomed-in portion includes the first portion of the field-of-view of the user, the other portion of the field-of-view of the user, the object, and the other object.

5. The head-wearable device of claim 4, wherein presenting the zoomed-in portion of the field-of-view of the user includes:
replacing the XR augment and the other XR augment with a first object-tag augment, associated with the object, and a second object-tag augment, associated with the other object, respectively.

6. The head-wearable device of claim 5, wherein presenting the zoomed-in portion of the field-of-view of the user further includes:
indicating, to the user, that the first object-tag augment is currently selected,
in response to the user performing a scroll gesture, indicating, to the user, that the second object-tag augment is currently selected,
in response to the user performing a select gesture, replacing the zoomed-in portion of the field-of-view with an additional XR augment, wherein the additional XR augment:
appears to overlie the second portion of the field-of-view of the user, and
includes one or more additional object-specific selectable elements, each additional object-specific selectable element associated with a respective additional object-specific action.

7. The head-wearable device of claim 4, wherein the presenting the zoomed-in portion of the field-of-view of the user is in response to the user performing a zoom gesture.

8. The head-wearable device of claim 1, wherein:
the head-wearable device further comprises one or more speakers, and
the one or more programs further include instructions for:
while the head-wearable device is worn by the user:
in accordance with the determination that the first user eye movement is focused on the first XR augment for the first predetermined time, presenting an audio cue to the user, wherein the audio cue includes a description of the object.

9. The head-wearable device of claim 1, wherein each object-specific selectable element includes a representation of the object.

10. The head-wearable device of claim 1, wherein:
the head-wearable device further comprises at least one of an eye-tracking camera and an inertial measurement unit (IMU), and
the first user eye movement and the second user eye movement are detected by the at least one of the eye-tracking camera and the IMU.

11. A non-transitory, computer-readable storage medium storing instructions that, when executed by one or more processors of a head-wearable device that includes a display, cause the head-wearable device to perform operations including:
while the head-wearable device is worn by a user:
in response to a detection of an object within a field-of-view of the user, presenting, via the display, a first extended reality (XR) augment overlaid over a first portion of the field-of-view of the user that is associated with the object;
in accordance with a determination that a first user eye movement is focused on the first XR augment for a first predetermined time, replacing the first XR augment with a second XR augment, wherein the second XR augment:
appears to overlie a second portion of the field-of-view of the user, and
includes one or more focus-action selectable elements, each focus-action selectable element associated with an object-specific action; and
while the second XR augment is presented, in accordance with a determination that a second user eye movement is focused outside a perimeter of the second XR augment for a second predetermined time, replacing the second XR augment with a third XR augment, wherein the third XR augment:
appears to overlie a third portion of the field-of-view of the user, and includes one or more object-specific selectable elements, each object-specific selectable element associated with a respective object-specific action.

12. The non-transitory, computer-readable storage medium of claim 11, wherein the instructions, when executed by the one or more processors, further cause the head-wearable device to perform operations including:
while the head-wearable device is worn by the user:
in response to a detection of another object within the field-of-view of the user, presenting, via the display, another XR augment, wherein the other XR augment appears to overlie over another portion of the field-of-view of the user that is associated with the other object.

13. The non-transitory, computer-readable storage medium of claim 12, wherein the instructions, when executed by the one or more processors, further cause the head-wearable device to perform operations including:
while the head-wearable device is worn by the user:
in accordance with a determination that a third user eye movement is focused on the first XR augment and the other XR augment, presenting, via the display, a zoomed-in portion of the field-of-view of the user, wherein the zoomed-in portion includes the first portion of the field-of-view of the user, the other portion of the field-of-view of the user, the object, and the other object.

14. The non-transitory, computer-readable storage medium of claim 13, wherein the presenting the zoomed-in portion of the field-of-view of the user is in response to the user performing a zoom gesture.

15. The non-transitory, computer-readable storage medium of claim 11, wherein:
the head-wearable device further comprises one or more speakers, and
the instructions, when executed by the one or more processors, further cause the head-wearable device to perform operations including:
while the head-wearable device is worn by the user:
in accordance with the determination that the first user eye movement is focused on the first XR augment for the first predetermined time, presenting an audio cue to the user, wherein the audio cue includes a description of the object.

16. A method, comprising:
while a head-wearable device is worn by a user:
in response to a detection of an object within a field-of-view of a user, presenting, via a display of the head-wearable device, a first extended reality (XR) augment overlaid over a first portion of the field-of-view of the user that is associated with the object;
in accordance with a determination that a first user eye movement is focused on the first XR augment for a first predetermined time, replacing the first XR augment with a second XR augment, wherein the second XR augment:
appears to overlie a second portion of the field-of-view of the user, and
includes one or more focus-action selectable elements, each focus-action selectable element associated with an object-specific action; and
while the second XR augment is presented, in accordance with a determination that a second user eye movement is focused outside a perimeter of the second XR augment for a second predetermined time, replacing the second XR augment with a third XR augment, wherein the third XR augment:
appears to overlie a third portion of the field-of-view of the user, and
includes one or more object-specific selectable elements, each object-specific selectable element associated with a respective object-specific action.

17. The method of claim 16, further comprising:
while the head-wearable device is worn by the user:
in response to a detection of another object within the field-of-view of the user, presenting, via the display, another XR augment, wherein the other XR augment appears to overlie over another portion of the field-of-view of the user that is associated with the other object.

18. The method of claim 17, further comprising:
while the head-wearable device is worn by the user:
in accordance with a determination that a third user eye movement is focused on the first XR augment and the other XR augment, presenting, via the display, a zoomed-in portion of the field-of-view of the user, wherein the zoomed-in portion includes the first portion of the field-of-view of the user, the other portion of the field-of-view of the user, the object, and the other object.

19. The method of claim 18, wherein the presenting the zoomed-in portion of the field-of-view of the user is in response to the user performing a zoom gesture.

20. The method of claim 17, wherein:
the head-wearable device further comprises one or more speakers, and
the method further comprises:
while the head-wearable device is worn by the user:
in accordance with the determination that the first user eye movement is focused on the first XR augment for the first predetermined time, presenting an audio cue to the user, wherein the audio cue includes a description of the object.
